(19) United States
(12) Patent Application Publication
(10) Pub. No.: US 2015/0158602 A1
(43) Pub. Date: Jun. 11, 2015

(54) INCLINED ORBIT SATELLITE SYSTEMS

(71) Applicant: TAWSAT LIMITED, Lake Worth, FL (US)

(72) Inventors: David MARSHACK, Bethesda, MD (US); Jeffrey FREEDMAN, Laurel, MD (US)

(73) Assignee: TAWSAT LIMITED, Lake Worth, FL (US)

(21) Appl. No.: 14/284,113

(22) Filed: May 21, 2014

Related U.S. Application Data
(60) Provisional application No. 61/914,766, filed on Dec. 11, 2013.
(60) Provisional application No. 61/914,779, filed on Dec. 11, 2013.
(60) Provisional application No. 61/914,778, filed on Dec. 11, 2013.
(60) Provisional application No. 61/941,852, filed on Feb. 19, 2014.

(51) Int. Cl. B64G 1/10; H01Q 3/24; G01S 19/13; H01Q 3/20

(52) U.S. Cl. CPC B64G 1/1085; B64G 1/1007; H01Q 3/20; H01Q 3/24; G01S 19/13

(57) ABSTRACT

The present disclosure is directed to an inclined geosynchronous orbit satellite system that can efficiently provide continuous communication to multiple geographic regions across the world using satellites in inclined geosynchronous orbital paths having an equatorial crossing and enabling the reuse of frequencies assigned within GSO orbital locations. The inclined orbit satellite system can include multiple inclined orbit satellites that are capable of co-existing with geostationary satellites to provide continuous uninterrupted service.

### REFERENCE TO RELATED APPLICATIONS

This application is a nonprovisional of U.S. Provisional Application No. 61/914,766, “COMMUNICATION FOR SATELLITES WITH INCLINED ORBITS”, filed Dec. 11, 2013; U.S. Provisional Application No. 61/914,779, “GROUND SYSTEM FOR HIGHLY INCLINED GEOSYNCHRONOUS SATELLITES”, filed Dec. 11, 2013; U.S. Provisional Application No. 61/914,778, “SYSTEM FOR COORDINATING COMMUNICATIONS WITH HIGHLY INCLINED GEOSYNCHRONOUS SATELLITES”, filed Dec. 11, 2013; and U.S. Provisional Application No. 61/941,852, “SYSTEM FOR SATELLITES WITH INCLINED ORBITS”, filed Feb. 19, 2014, the entire contents of which are incorporated herein by reference.

### FIELD OF THE INVENTION

The present disclosure relates generally to satellite systems. More particularly, the present disclosure relates to highly inclined orbit satellite systems.

### BACKGROUND OF THE INVENTION

The term geosynchronous satellite is used to describe a satellite having a period of revolution approximately equal to the period of rotation of the Earth about its axis. The term geostationary satellite, or GSO satellite, is used to describe a geosynchronous satellite having a circular and direct orbit lying in the plane defined by the Earth's equator. Since a GSO satellite has an orbit with a period of about twenty four hours, when viewed from the surface of the earth a GSO satellite appears to be located at a fixed location in the sky, approximately 35,700 km above the earth's equator.

### SUMMARY OF THE INVENTION

There is a current need to provide additional radio services using frequencies already used by active GSO satellites. However, there is also an increasingly limited amount of space available in which to deploy additional GSO satellites in GSO orbital locations. Thus, while there is a need to deploy additional satellites, it is becoming increasingly more difficult to accommodate such additional satellites in GSO orbital locations.

An inclined orbit satellite system is disclosed that can efficiently provide continuous communication to multiple regions across the world using satellites in inclined orbits. To co-exist with GSO satellites, the inclined orbit satellites of the satellite system can turn off, mute, or attenuate service when they are near the equator. Thus, multiple inclined orbit satellites may be required to provide continuous uninterrupted service.

### BRIEF DESCRIPTION OF THE DRAWINGS

FIG. 1 illustrates examples of inclined geosynchronous satellite patterns.

FIG. 2 illustrates an example of a satellite's spot beam movement during its inclined orbit.

FIG. 3 illustrates an example of a satellite's regional beam changes during its inclined orbit.

FIG. 4 illustrates an example of an overview of an inclined orbit satellite system.

FIG. 5A illustrates an example of a two satellite inclined orbit satellite system.

FIG. 5B illustrates an example of a three satellite inclined orbit satellite system.

FIG. 6 illustrates an example of a user terminal or gateway antenna system.

FIG. 7A illustrates an example of an upper latitude feed array elemental beam pattern.

FIG. 7B illustrates an example of a lower latitude feed array elemental beam pattern.

FIG. 8 illustrates an example block diagram for a receiver unit.

FIG. 9 illustrates an example block diagram for a transmit unit.

### DETAILED DESCRIPTION OF THE INVENTION

Inclined orbit satellite systems are described herein that may efficiently provide continuous communication to geographic regions across the world using highly inclined orbit satellites. There are, however, a number of system challenges to be addressed. Those system challenges, and solutions to those challenges provided in accordance with the present disclosure, are described below.

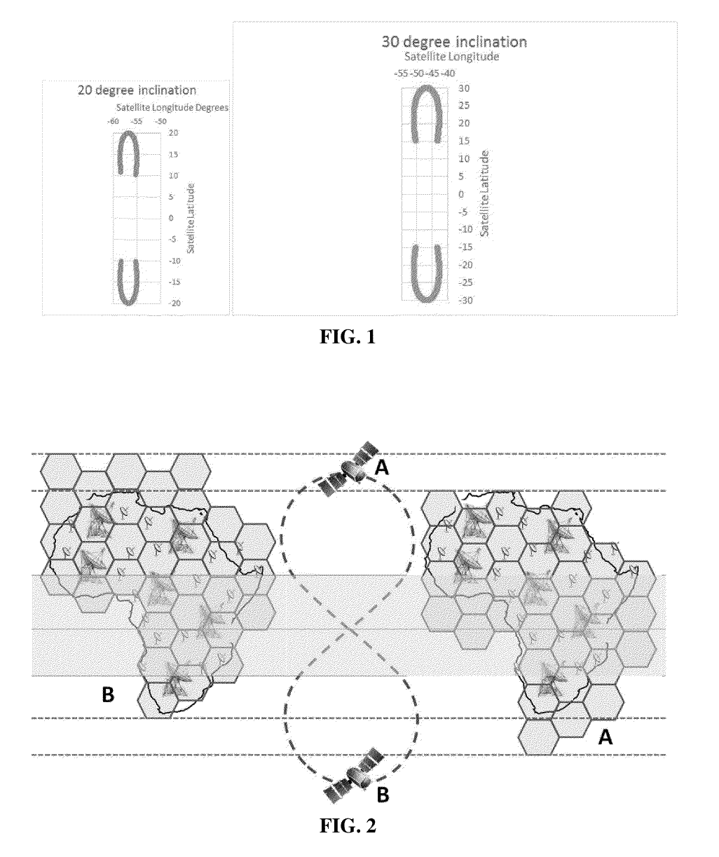

The term highly inclined orbit satellite, or HIO satellite, is used to describe a satellite that may have an altitude similar to that of a GSO satellite but which has an orbit inclination that causes it to move north and south of the equator at a fixed longitude, defining a pattern over the course of a twenty four hour orbit which, when viewed from the Earth, generally resembles a figure eight. Accordingly, highly inclined orbits are considered geosynchronous but not geostationary. FIG. 1 illustrates an example pattern of the inclined geosynchronous satellites as seen from the ground. The satellites and the ground stations that the satellites may communicate with may be based, for example, on the satellites and ground stations described in U.S. patent application Ser. No. 13/803,449, entitled “Satellite Beamforming Using Split Switches” and filed on Mar. 14, 2013, hereby incorporated by reference in its entirety.

Satellite antenna coverage for a specific area may vary depending upon the position of the HIO satellite in the figure eight orbital pattern. For example, there may be a large variation in coverage when an HIO satellite in the Northern Hemisphere is serving a geographic area in the Southern Hemisphere or vice versa. FIG. 2 illustrates an example of a satellite's spot beam movement during a 24-hour geosynchronous orbit. The figure eight in the center of FIG. 2 represents the satellite's highly inclined orbit (HIO) relative to the equator (which is depicted as the central horizontal line in FIG. 2). Reference letter A designates the satellite's northernmost position in its orbital path. Reference letter B designates the satellite's southernmost position in its orbital path. In this example, as the satellite reaches position B, the beams may be shifted north, providing a coverage area over the African continent (for example) similar to that depicted on the left hand side of FIG. 2. Similarly, as the satellite reaches position A, the beams may be shifted south, providing a coverage area over Africa similar to that depicted on the right hand side of FIG. 2.

In this example, as shown in FIG. 2, it can be seen that while most areas of Africa will be covered when the satellite reaches position A or position B, there may be a few areas which will receive limited or no coverage. Moreover, the areas receiving limited or no coverage will be different, depending on whether the satellite is in position A or in position B or in some other position along the figure eight orbital path. However, if multiple satellites are used in a coordinated fashion according to the techniques described herein, all areas will receive coverage irrespective of the position of the satellites along the orbital path.

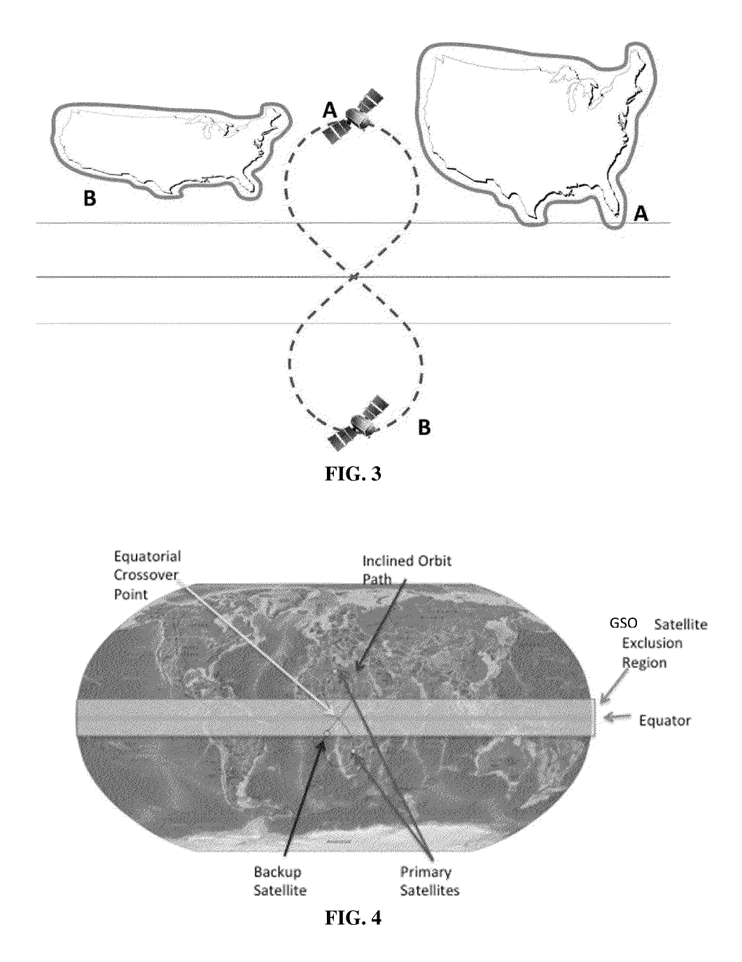

Satellite regional beam coverage for a specific area may vary depending upon the position of the HIO satellite in the figure eight orbital pattern. For example, satellite beam coverage may be stretched when an HIO satellite in the Northern Hemisphere is serving a geographic area in the Southern Hemisphere or vice versa. FIG. 3 illustrates an example of how regional beams may change as the satellite moves through its HIO. As in FIG. 2, the figure eight in the center of FIG. 3 represents a satellite's highly inclined orbit (HIO) relative to the equator. Reference letter A represents the satellite's northernmost position in its orbital path, and reference letter B represents the satellite's southernmost position. As the satellite reaches position A, countries (such as the U.S. for example) located in the northern hemisphere will receive the maximum signal strength from the beam, as illustrated, for example, on the right hand side of FIG. 3. As the satellite reaches position B, the signal strength received by Northern Hemisphere countries will be relatively less optimal, due to the curvature of the Earth and the greater distance between the Northern Hemisphere and the satellite in position B (as shown on the left hand side of FIG. 3).

In this example it can be seen that while all areas of the U.S. may be covered whether the satellite is in position A or in position B, optimum coverage is achieved when the satellite orbits above the Northern Hemisphere rather than the Southern Hemisphere. Moreover, the quality of coverage will be different, depending on the location of the satellite in its orbital path. However, if multiple satellites are used in a coordinated fashion according to the techniques described in the present disclosure, a more consistent quality of coverage may be achieved irrespective of the position of the satellites along the orbital path.

Spot beams may move relative to gateway and user terminal locations. Coverage may be improved by providing the satellite with a number of beams greater than the number of service areas. Interference between user terminals located in the same or adjacent spot beam coverage areas may be reduced by providing assigned satellite information to gateway and user terminals and/or by coordinating beam and frequency plans. When a satellite beam coverage changes due to the motion of the satellite the: (1) user terminals may have to change (handoff) to a new beam and frequency/polarization on the same satellite and possibly new beam/polarization and frequency on a new satellite; (2) user terminals may be assigned a new gateway when the user terminal is handed off to another satellite beam or another satellite; (3) gateways may have to be able to change to a new feeder link beam and may have to be able to assign capacity (a combination of beam (transmit and/or receive), polarization, power and frequency assignments) to satellite beams with active users; (4) a satellite may have to be able to switch capacity to the geographic area with active users; and/or (5) user terminals and Gateway Earth stations may also need to switch its earth station transmit and receive beams to another satellite.

An HIO satellite may share the same frequencies as a GSO satellite and may serve the same geographic area. This may be accomplished by operating an HIO satellite outside a specified GSO Satellite Exclusion Region about the equator. Two or more HIO satellites may be used in order to optimize the coverage of a specific geographic area using the same frequencies. By shutting off, muting, or attenuating transmissions when the HIO satellite passes near the equator, sharing with geostationary satellites may be possible. During the shutdown period of a first HIO satellite, a second HIO satellite can be used to provide uninterrupted service. Two or more HIO satellites can be used to cover individual longitudes. If the relative position of each HIO satellite within its figure eight pattern is designed in accordance with the techniques described herein, then a single additional satellite may serve as a backup for multiple pairs of satellites across multiple longitudes.

An HIO satellite system in accordance with the present disclosure can consist of one or more satellites deployed in a constellation about a constant Equatorial Crossover Point. In addition, the HIO satellite system of the present disclosure may be able to use all frequencies allowed in the GSO plane (C, Ka, Ku, X, and others). For example, assuming a 6-degree orbital spacing at the cross over point at the equator, 60 of these HIO systems may be deployed.

One example of an HIO satellite system is illustrated in FIG. 4. In this example, three HIO satellites have the same longitude crossing. Two of these satellites may be active and one may be a backup satellite. The three satellites can travel the same inclined orbital path, each satellite crossing the equator at the same longitude at an Equatorial Crossover Point. The satellites can be positioned so that, at any given time, at least one satellite may be visible over the coverage area. A user station located within the coverage area may track the HIO satellite that is identified as providing service to that user.

A HIO constellation that coordinates satellites, beams, power, coverage, capacity and frequency assignments throughout the orbit period may be described as follows.

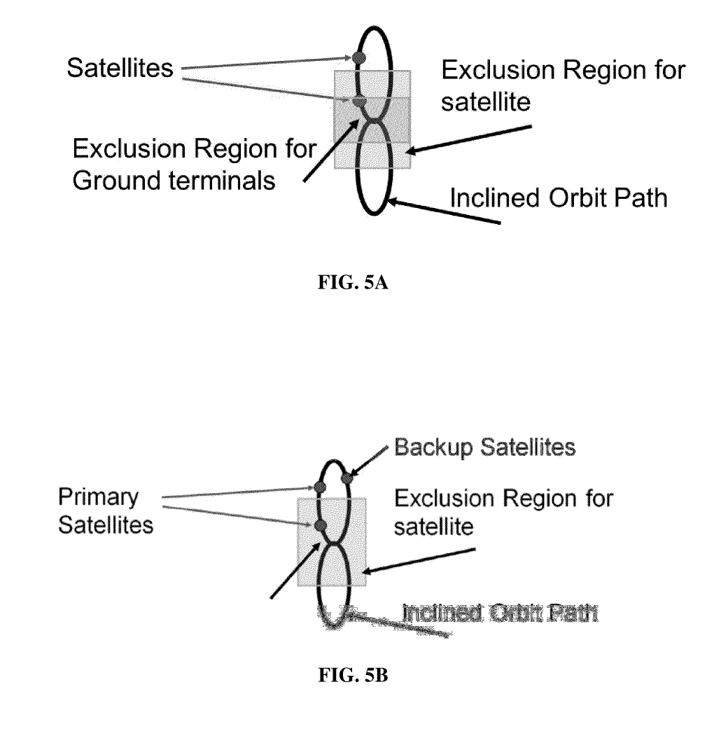

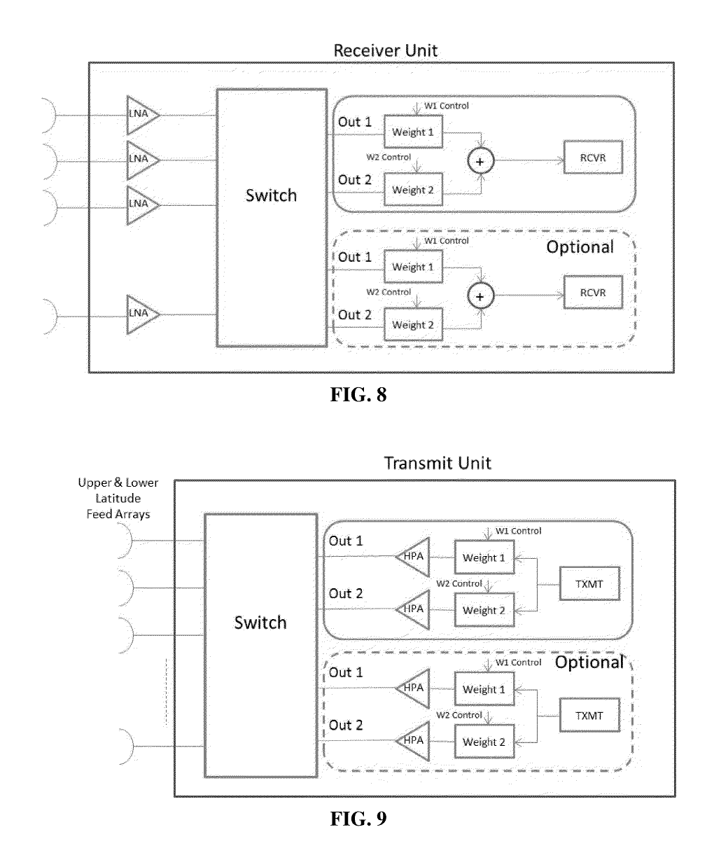

Referring to FIG. 5A, an example is described in which two satellites in inclined geosynchronous orbits may provide uplink and/or downlink services to multiple geographically distributed ground terminals. Each of these satellites may turn off, mute or attenuate transmissions near the equator in an exclusion zone in order not to cause interference to ground users of geostationary satellites. At the same time ground users of the HIO satellites may also be able to shut down, mute, or attenuate service so as not to interfere with geostationary satellite uplink signals. In a preferred embodiment, the two HIO satellites can be separated by four hours so that one satellite is over the same location within the FIG. 8 after four hours. The exclusion latitudes for both uplink from ground terminals and downlink from the satellite can be, for example, at ½ inclination. However, the exclusion zone may be less or more than ½ inclination depending upon the radio interference potential between the services on the HIO and the GSO satellites. If any HIO satellite is less than ½ inclination angle, then all uplink and downlink signals to and from the HIO satellite may be shut down. In this way, there may always be one HIO satellite out of the exclusion zone at all times.

Referring to FIG. 5B, an example is described in which three satellites in HIO may provide uplink and/or downlink services to multiple geographically distributed ground terminals. The relative position of the two HIO satellites may be positioned so that if a third HIO satellite were to be added, the third HIO satellite may be positioned so that two HIO satellites are always out of the exclusion zone. In this way, one of the satellites may provide backup communications or all three can be used to provide continuous coverage communications. In this example, the three satellites may be placed at four hour delays with respect to each other so that the third satellite is 8 hours behind the first satellite and the second satellite is four hours behind the first. Any one of these satellites may be the backup satellite.

Additional HIO satellites at additional longitudes can also be used to provide service to the same or different geographic areas. Furthermore, the first satellite located at each longitude may be in the same inertial orbital plane. The second satellite in each longitude can be in a common orbital plane.

Because it may take minimal fuel to move satellites within an orbital plane, a single launch vehicle can be used to launch a first set of one to three HIO satellites and a second launch vehicle can be used to launch a second set of HIO satellites.

The first satellite in each longitude may be delayed by Delay=24*(lonᵢ)/360 hours, where lonᵢ is the i^{th} occupied longitude. Likewise the second satellite in each longitude may be delayed by Delay=24*(loni)/360 hours+4, where lonᵢ is the i^{th} occupied longitude. An additional satellite may be in an orbital plane that serves as backup to all of the satellites at all of the longitudes. The backup satellites may be delayed by: Delay=24*(lon_{B})/360 hours+8, where lon_{B} is the longitude of the backup satellite. This may be done to ensure that satellites at different longitudes are in the same orbital plane. In case of a satellite failure, any one of the satellites in the same orbital plane can back up any other satellite by drifting from one longitude to another longitude orbit. Keeping the satellites in the same plane can minimize the fuel required to perform this backup maneuver.

A HIO satellite providing regional coverage can use two or more antennas. One or more of the satellites may be optimized for coverage from the Northern Hemisphere and one or more optimized for coverage from the Southern Hemisphere. A satellite may switch between antennas depending on which Hemisphere it is covering. For example, this can be accomplished by: (1) separate reflectors or feed systems for the two antennas; (2) a single satellite antenna that tracks the coverage area as it moves through its FIG. 8 orbit; or (3) a single satellite beam forming system that could provide optimum satellite beam coverages from each Hemisphere.

A HIO satellite system, which does not provide service to geographic areas when the satellite is located near the equator, may eliminate interference to and from its associated earth stations with directional antennas from and into GSO satellites.

A HIO satellite providing spot beam coverage may form excess beams to take into account the HIO satellite movement through its twenty four hour geosynchronous orbit. For example, this can be accomplished by: (1) adding extra satellite antenna feeds that take into account the north and south satellite variation in the orbit; or (2) a satellite beam forming system with sufficient feeds that provide coverage taking into account the HIO satellite orbital variation.

A HIO satellite may flexibly switch capacity between feed elements or separate antennas. For example, this can be accomplished by: (1) a frequency channelizing system; (2) a switch matrix on the satellite; or (3) Earth stations with directional antennas that can switch capacity within beams of one satellite and between HIO satellites.

The HIO system may operate autonomously, or with use of a global resource management system (GRM) that operates at the Network Operations Center and generates user terminal and gateway connectivity maps and user and gateway frequency beam and polarization assignments for each satellite. The GRM may be connected to each gateway over a low data rate link (terrestrial or satellite). The gateways may notify users of specific satellite beam and polarization assignments, frequency assignments, and handoffs to new gateways or satellites over the satellite link. The gateways may notify each of the users, over the satellite link, of handoffs to new satellites and beams, new frequency, and polarization assignments and assignments to new gateways. Since orbits are repeating every twenty-four hours, the GRM may generate repeating schedules for each HIO satellite for both users and gateways that can remain fixed as long as service requirements remain fixed.

The gateway, satellite, and user terminals may receive a schedule from the GRM, which may describe the time dependent frequency assignments, beam and polarization assignments, and earth station and satellite beam pointing directions. The gateway, user terminals, and satellites may follow this schedule in order to provide continuous service across multiple HIO satellites and orbit locations within the same twenty-four hour FIG. 8 orbit with the same Equatorial Crossing Point.

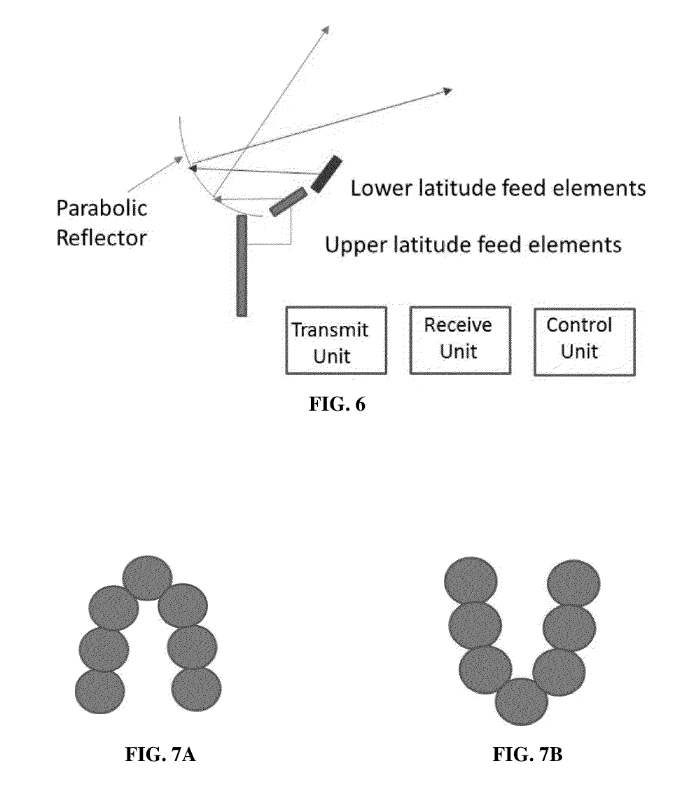

A user terminal or gateway antenna system may dynamically cover various regions as the HIO satellite moves through its orbit. Additionally or alternatively, a user terminal or gateway antenna may simultaneously receive and/or transmit signals to/from multiple satellites as it follows the HIO satellites throughout their orbit. An example of a user terminal or gateway antenna system is illustrated in FIG. 6.

The user terminal or gateway antenna system may include a reflector, an array of feed elements for an upper latitude satellite, an array of feed elements for a lower latitude satellite, a transmitter unit and/or a receive unit, and a control unit. The transmit unit may transmit the signals to a HIO satellite, the receiver unit may receive the signals from a HIO satellite, and the control unit may configure these units so that the user terminal or gateway antennas track the HIO satellite(s).

The user terminal or gateway feed arrays may be designed to cover the orbit of the active HIO satellite as seen from the Earth. FIG. 7A illustrates an example of the elemental beams generated from the feed array for the user terminal or gateway communicating with HIO satellites in the upper latitudes. FIG. 7B illustrates an example of elemental beams generated from the feed array for the user terminal or gateway communicating with HIO satellites located in the lower latitudes. These elemental beam patterns may be designed to cover the HIO satellites during the active HIO transmission periods as the HIO satellites travel over their orbit.

The user terminal or gateway feed arrays may also be designed to receive and/or transmit signals. Each of these user terminal or gateway feeds may be connected to a receiver unit and a transmitter unit, respectively. The transmitter unit and/or receiver unit may employ two of these feed elements at any one time. Additionally or alternatively, more than two feed elements may be employed as well. The two feed elements may be selected such that their feed elemental beam patterns overlap the HIO satellite. Complex weights may be applied to transmit and/or receive feed elements, respectively, and the resulting signals received or transmitted from each feed element may be added to create a virtual receiver or transmit beam, respectively, that has its peak gain focused at the HIO satellite.

FIG. 8 illustrates an example block diagram for a user terminal or gateway receiver unit in accordance with the present disclosure. In this example the upper and lower latitude feed element arrays may be first amplified and then switched. Only one pair of adjacent element paths may be output from the switch. Complex weights may control amplitudes and phases of the received signals and may be applied to each of these element paths. The complex weights may be configurable so an intelligent controller can point the virtual beam at the satellite. The signals may then be added to form a beam focused at the HIO satellite. Specifically, the received signals in each feed element array can be amplified and phase shifted according to a specific algorithm to provide a virtual beam with maximum gain focused at the HIO satellite. The receiver may then detect and process the received signals. More than one HIO satellite may be simultaneously served by using different feed elements through the switch matrix and a separate receiver in the user terminal or gateway. Such an operational mode is depicted with the dotted line box labeled optional in FIG. 8.

FIG. 9 illustrates an example block diagram for a transmit unit for a user terminal or gateway in accordance with the present disclosure. In this example, a signal from the transmitter may be split along two paths. Configurable complex amplitude attenuation and phase shifting may be applied to each respective signal path before each signal path is amplified. The two paths may then be applied via a switch matrix to two adjacent transmit feed elements. The energy transmitted from these two feed elements can be combined in space to form a virtual beam that has its peak gain focused on the HIO satellite. More than one HIO satellite may be simultaneously served by using different feed elements through the switch matrix, a separate set of amplitude attenuators, phase shifters, and transmitters. Such an operational mode is depicted with the dotted line box labeled optional in FIG. 9.

A control unit may provide the intelligence for the user terminal or gateway system. The control unit may follow a schedule that repeats over a twenty four hour orbit period. The control unit can calculate, using a specific algorithm, which transmit and receive elements are active at any given time to communicate with the HIO satellite(s). The control unit may also change the transmit and receive amplitude attenuators and phase shifters continually in order to maintain maximum gain and focus of the virtual beam at the HIO satellite as it moves throughout its orbit.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations of the above examples are possible in view of the above description. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed:

1. A method comprising:
providing a first satellite that travels an inclined geosynchronous orbital path having an equatorial crossing,
preventing transmissions between the first satellite and Earth stations when the first satellite travels at least a first portion of the path,
permitting transmissions between the first satellite and Earth stations when the first satellite travels at least a second portion of the path, the first portion of the path being relatively closer to the equatorial crossing than the second portion of the path.

2. The method of claim 1 comprising:
providing a second satellite that travels the inclined geosynchronous orbital path,
preventing transmissions between the second satellite and Earth stations when the second satellite travels at least the first portion of the path, and
permitting transmissions between the second satellite and Earth stations when the second satellite travels at least the second portion of the path.

3. The method of claim 2 comprising:
establishing relative spacing between the first and second satellites which enables transmissions between at least one of the first and second satellites and Earth stations at any time.

4. The method of claim 2 comprising:
providing a third satellite that travels the inclined geosynchronous orbital path,
preventing transmissions between the third satellite and Earth stations when the third satellite travels at least the first portion of the path, and
permitting transmissions between the third satellite and Earth stations when the third satellite travels at least the second portion of the path.

5. The method of claim 4 comprising:
establishing relative spacing among the first, second and third satellites which enables transmissions between at least two of the first, second and third satellites and Earth stations at any time.

6. The method of claim 4, wherein at least one of the first, second, and third satellites is configured to be a backup satellite for any other satellite in the same orbital plane as the first, second, and third satellites.

7. A system comprising:
a first satellite that travels an inclined geosynchronous orbital path having an equatorial crossing,
a transmitter in the first satellite that attenuates transmissions between the first satellite and Earth stations when the first satellite travels at least a first portion of the path, wherein the attenuated transmissions prevent interference with transmissions between geostationary satellites and Earth stations,
a transmitter in the first satellite that permits unattenuated transmissions between the first satellite and Earth stations when the first satellite travels at least a second portion of the path, the first portion of the path being relatively closer to the equatorial crossing than the second portion of the path.

8. The system of claim 7 comprising:
a second satellite that travels the inclined geosynchronous orbital path,
a transmitter in the second satellite that attenuates transmissions between the second satellite and Earth stations when the second satellite travels at least the first portion of the path,
a transmitter in the second satellite that permits unattenuated transmissions between the second satellite and Earth stations when the second satellite travels at least the second portion of the path.

9. The system of claim 8, wherein the first and second satellites are relatively spaced to enable transmissions between at least one of the first and second satellites and Earth stations at any time.

10. The system of claim 8 comprising:
a third satellite that travels the inclined geosynchronous orbital path,
a transmitter in the third satellite that attenuates transmissions between the third satellite and Earth stations when the third satellite travels at least the first portion of the path, and
a transmitter in the third satellite that permits unattenuated transmissions between the third satellite and Earth stations when the third satellite travels at least the second portion of the path.

11. The system of claim 10, wherein the first, second and third satellites are relatively spaced to enable transmissions between at least two of the first, second and third satellites and Earth stations at any time.

12. The system of claim 10, wherein at least one of the first, second, and third satellites is configured to be a backup satellite for any other satellite in the same orbital plane as the first, second, and third satellites.

13. A system comprising:
a first satellite that travels an inclined geosynchronous orbital path having an equatorial crossing,
a transmitter in an Earth station that attenuates transmissions between the Earth station and the first satellite when the first satellite travels at least a first portion of the path, the attenuated transmissions prevent interference with transmissions between geostationary satellites and Earth stations,
a transmitter in the Earth station that permits unattenuated transmissions between the Earth station and the first satellite when the first satellite travels at least a second portion of the path, the first portion of the path being relatively closer to the equatorial crossing than the second portion of the path.

14. The system of claim 13 comprising:
a second satellite that travels the inclined geosynchronous orbital path,
a transmitter in the Earth station that attenuates transmissions between the Earth station and the second satellite when the second satellite travels at least a first portion of the path,
a transmitter in the Earth station that permits unattenuated transmissions between the Earth station and the second satellite when the second satellite travels at least a second portion of the path.

15. The system of claim 14, wherein the first and second satellites are relatively spaced to enable transmissions between at least one of the first and second satellites and Earth stations at any time.

16. The system of claim 14 comprising:
a third satellite that travels the inclined geosynchronous orbital path,
a transmitter in the Earth station that attenuates transmissions between the Earth station and the third satellite when the third satellite travels at least a first portion of the path,
a transmitter in the Earth station that permits unattenuated transmissions between the Earth station and the third satellite when the third satellite travels at least a second portion of the path.

17. The system of claim 16, wherein the first, second, and third satellites are relatively spaced to enable transmissions between at least two of the first, second and third satellites and Earth stations at any time.

18. The system of claim 16, wherein at least one of the first, second, and third satellites is configured to be a backup satellite for any other satellite in the same orbital plane as the first, second, and third satellites.

19. A method comprising:
receiving a transmission originating from a first satellite when the first satellite travels at least a first portion of an inclined geosynchronous orbital path having an equatorial crossing,
not receiving a transmission originating from the first satellite when the first satellite travels at least a second portion of an inclined geosynchronous orbital path having an equatorial crossing, the first portion of the path being relatively closer to the equatorial crossing than the second portion of the path.

20. The method of claim 19 comprising:
receiving a transmission originating from a second satellite when the second satellite travels at least the first portion of the inclined geosynchronous orbital path having an equatorial crossing,
not receiving a transmission originating from the second satellite when the second satellite travels at least the second portion of the inclined geosynchronous orbital path having an equatorial crossing.

21. The method of claim 20, wherein the first and second satellites are relatively spaced to enable receipt of a transmission from at least one of the first and second satellites at any time.

22. The method of claim 20 comprising:
receiving a transmission originating from a third satellite when the third satellite travels at least the first portion of the inclined geosynchronous orbital path having an equatorial crossing,
not receiving a transmission originating from the third satellite when the third satellite travels at least the second portion of the inclined geosynchronous orbital path having an equatorial crossing.

23. The method of claim 22 wherein the first, second and third satellites are relatively spaced to enable receipt of a transmission from at least two of the first, second and third satellites at any time.

24. The method of claim 22, wherein at least one of the first, second, and third satellites is configured to be a backup satellite for any other satellite in the same orbital plane as the first, second, and third satellites.

25. An antenna system comprising:
a reflector configured to reflect signals to and from a satellite traveling an inclined geosynchronous orbital path having an equatorial crossing,
at least one feed element array configured to receive signals from the reflector and transmit signals to the reflector,
a transmit unit connected to the at least one feed element array configured to transmit signals for communication with the satellite to the at least one feed array,
a receiver unit connected to the at least one feed element array configured to receive and process signals from the at least one feed element array,
wherein the antenna system is configured to communicate with the satellite when the satellite travels at least a first portion of the path being relatively farther from the equatorial crossing than a second portion of the path.

26. The system of claim 25, further comprising a control unit configured to control the reflector, the at least one feed element array, the receiver unit, and the transmit unit in order to track the satellite throughout its inclined geosynchronous orbital path.

27. The system of claim 25, wherein the at least one feed element array comprises an upper latitude feed element array and a lower latitude feed element array.

28. The system of claim 25, wherein the antenna system is configured to continuously communicate with at least one of multiple satellites traveling the inclined geosynchronous orbital path.

29. The system of claim 25, wherein the antenna system is configured to continuously communicate with at least two of multiple satellites traveling the inclined geosynchronous orbital path.
